(19) United States
(12) Patent Application Publication
(10) Pub. No.: US 2008/0077949 A1
(43) Pub. Date: Mar. 27, 2008

(54) Rotating data storage device anti-shake mechanism

(75) Inventor: Lien Tsung Yeh, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/525,325

(22) Filed: Sep. 22, 2006

(51) Int. Cl. G11B 19/20

(52) U.S. Cl. 720/698; 360/97.02

(57) ABSTRACT

A rotating-type data storage device anti-shake mechanism is proposed, which is designed for use with a rotating-type data storage device, such as a hard disk drive or an optical disk drive, for providing the data storage device with an anti-shake capability during operation. The proposed anti-shake mechanism is characterized by the arrangement of a set of weighty members symmetrically about the rotating axis of the disk on the enclosure of the data storage device, which can help increase the mass inertia torque around the disk's rotating axis and thereby reduce the angular velocity of the rotating disk, thus effectively reducing shake on the data storage device. This anti-shake feature allows a hard disk drive to have more reliable data read/write operations.

### BACKGROUND OF THE INVENTION

1. Field of the Invention

This invention relates to computer hardware technology, and more particularly, to a rotating-type data storage device anti-shake mechanism which is designed for use in conjunction with a rotating-type data storage device, such as a hard disk drive or a CD/DVD drive, for the purpose of providing the rotating-type data storage device with an anti-shake capability that can help assure the performance of data access operations of the data storage device.

2. Description of Related Art

Computer platforms, such as network servers, desktop computers, and notebook computers, typically utilize hard disk drives as a large-volume and permanent data storage unit for storing computer data. In the applications of network servers, SATA (Serial ATA, where ATA=Advanced Technology Attachment) compliant hard disk drives are the most widely employed data storage devices.

In order to offer compactness, SATA hard disk drives for network servers are now downsized to the level of 2.5 inches. At this level of compactness, however, the total weight of the hard disk drive is also reduced, which would undesirably reduce the anti-shake capability of the hard disk drive. Presently, hard disk drives utilizes a round magnetic disk as the data storage medium, which rotates about a rotating axis during data read/write operations to allow the read/write head to gain access to each section of the disk.

However, since a 2.5″ hard disk drive is very light in weight, the rotational torques produced by the internal magnetic disk and the external fans would easily cause the hard disk drive to vibrate violently, thus adversely affecting the positioning of the read/write head of the hard disk drive to the precise locations of the disk. As a consequence, the performance of the data read/write operations would be adversely degraded. Furthermore, the excessive vibration of the hard disk drive would also undesirably cause noisy sounds that might annoy the user.

### SUMMARY OF THE INVENTION

It is therefore an objective of this invention to provide a rotating-type data storage device anti-shake mechanism which can provide an enhanced anti-shake capability to a light-weight hard disk drive to help assure the performance of data access operations of the data storage device.

It is another objective of this invention to provide a rotating-type data storage device anti-shake mechanism which can help allow a hard disk drive to produce low noise during operation.

Broadly speaking, the rotating-type data storage device anti-shake mechanism according to the invention is designed for use in conjunction with a rotating-type data storage device, such as a hard disk drive or a CD/DVD drive, for the purpose of providing the rotating-type data storage device with an anti-shake capability that can help assure the performance of data access operations of the data storage device.

In structure, the rotating-type data storage device anti-shake mechanism according to the invention comprises: (A) a chassis, which is used to support the rotating axis and the data storage disk of the rotating-type data storage device; and (B) a set of weighty members, which are fastened to the chassis and laid around the rotating axis of the data storage disk.

The rotating-type data storage device anti-shake mechanism according to the invention is characterized by the arrangement of a set of weighty members symmetrically about the rotating axis of the disk on the enclosure of the data storage device, which can help increase the mass inertia torque around the disk's rotating axis and thereby reduce the angular velocity of the rotating disk, thus effectively reducing shake on the data storage device. This anti-shake feature allows a hard disk drive to have more reliable data read/write operations.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a top view of a hard disk drive installed with the rotating-type data storage device anti-shake mechanism of the invention; and

FIG. 2 is a schematic diagram showing a cross-sectional view of a hard disk drive installed with the rotating-type data storage device anti-shake mechanism of the invention.

### DETAILED DESCRIPTION OF PREFERRED EMBODIMENTS

The rotating-type data storage device anti-shake mechanism according to the invention is disclosed in full details by way of preferred embodiments in the following with reference to the accompanying drawings.

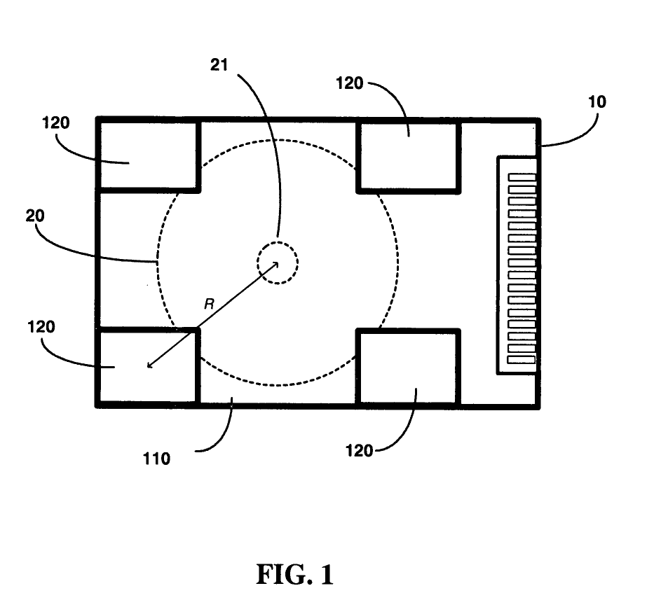

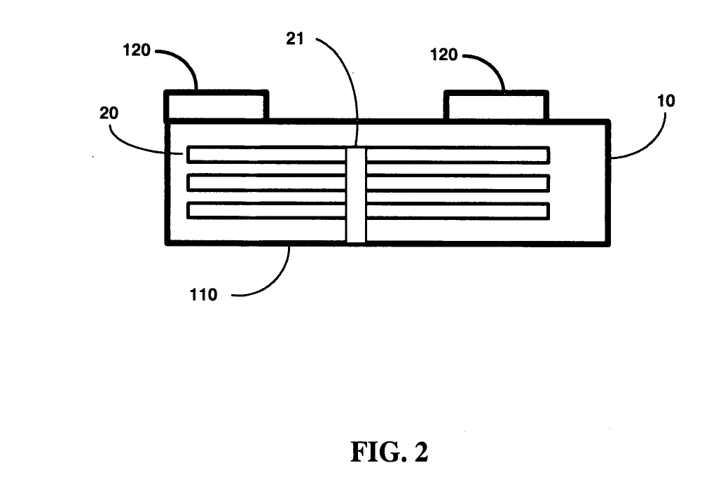

As shown in FIG. 1 and FIG. 2, the rotating-type data storage device anti-shake mechanism of the invention is designed for use in conjunction with a rotating-type data storage device 10 of the type having a data storage disk 20 that rotates about a rotating axis 21 during data access operations. In actual applications, for example, the rotating-type data storage device 10 can be either a hard disk drive or a CD/DVD drive, and the data storage disk 20 is a magnetic disk or an optical disk.

In the following description of preferred embodiments, it will be assumed that the rotating-type data storage device 10 is a hard disk drive. When the hard disk drive 10 is installed with the rotating-type data storage device anti-shake mechanism of the invention, it can help assure the performance of data access operations of the hard disk drive 10 by providing an enhanced anti-shake capability on the hard disk drive 10.

In structure, the rotating-type data storage device anti-shake mechanism of the invention comprises: a chassis 110 and a set of weighty members 120. Firstly, the respective attributes and functions of these two constituent components 110, 120 are described in details in the following.

The chassis 110 is used to securely support the hard disk drive 10 and the rotating axis 21 such that the data storage disk 20 can rotate smoothly during operation. In practical implementation, for example, the chassis 110 can be implemented by using the casing of the hard disk drive 10.

The weighty members 120 are each fastened to the chassis 110 and laid around the rotating axis 21 of the data storage disk 20, preferably in a symmetrical manner about the rotating axis 21. In practical implementation, for example, these weighty members 120 can be integrally formed into a single piece, or separately formed into multiple pieces. In the embodiment of FIG. 1, for example, the quantity of the weighty members 120 is 4; but broadly speaking, the quantity thereof is not limited to 4, and can be 2, 3, 5, or more. Moreover, in the embodiment of FIG. 1, the weighty members 120 are each formed in a square shape; but broadly speaking, the shape thereof is an arbitrary design choice.

Based on fundamental principles of dynamics,

T(f)=I*α(f)

where

T(f) represents the total of the torque produced by the data storage disk 20 while being rotated plus the external torque (if any) produced by other rotating devices, such as fans, and which is a function of the rotating frequency f;

α(f) represents the angular acceleration of the data storage disk 20 while being subjected to the total torque, and whose value will directly affect the data access performance of the hard disk drive 10; i.e., the larger α(f) becomes, the less the data access performance becomes; and

I represents the mass inertia torque of the weighty members 120, and I=k*M*R², where k is a constant, M is the mass of the weighty members 120, and R is the distance between the rotating axis 21 and each of the weighty members 120 (as shown in FIG. 1).

From the above-mentioned equation, it can be learned that the rotating-type data storage device anti-shake mechanism of the invention is best embodied in such a manner that the weighty members 120 are positioned as far away as possible from the rotating axis 21, i.e., the greater is R, the better is the anti-shake capability. Moreover, the weighty members 120 are best embodied as heavy as possible. In order to allow the hard disk drive 10 to be compact in size, the weighty members 120 are preferably made from materials having high hardness and specific weight, such as steel alloy or copper alloy.

During actual operation of the hard disk drive 10, the data storage disk 20 rotates about the rotating axis 21 to allow data read/write operations. As a result of the rotational torque from the rotating axis 21, it will cause the data storage disk 20 to vibrate. However, this vibration would be suppressed by the weighty members 120, thus allowing the data storage disk 20 to nonetheless rotate smoothly without being affected by the rotational torque; and therefore the data access operations of the hard disk drive 10 can be assured. Likewise, external vibrations from other sources such as fans can also be suppressed. Moreover, the weighty members 120 can also help suppress the generation of noisy sounds from the hard disk drive 10.

In conclusion, the invention provides a rotating-type data storage device anti-shake mechanism which is designed for use with a rotating-type data storage device, such as a hard disk drive or an optical disk drive, for providing the data storage device with an anti-shake capability during operation, and which is characterized by the arrangement of a set of weighty members symmetrically about the rotating axis of the disk on the enclosure of the data storage device, which can help increase the mass inertia torque around the disk's rotating axis and thereby reduce the angular velocity of the rotating disk, thus effectively reducing shake on the data storage device. This anti-shake feature allows a hard disk drive to have more reliable data read/write operations. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A rotating-type data storage device anti-shake mechanism for use with a rotating-type data storage device having a data storage disk that rotates about a rotating axis during data access operations, for providing the rotating-type data storage device with an anti-shake capability;
the rotating-type data storage device anti-shake mechanism comprising:
a chassis, which is used to support the rotating axis and the data storage disk of the rotating-type data storage device; and
a set of weighty members, which are fastened to the chassis and laid around the rotating axis.

2. The rotating-type data storage device anti-shake mechanism of claim 1, wherein the rotating-type data storage device is a hard disk drive.

3. The rotating-type data storage device anti-shake mechanism of claim 1, wherein the data storage disk is a CD/DVD drive.

4. The rotating-type data storage device anti-shake mechanism of claim 1, wherein the weighty members are each positioned at a maximum distance from the rotating axis.

5. The rotating-type data storage device anti-shake mechanism of claim 1, wherein the weighty members are arranged on the chassis in a symmetrical manner about the rotating axis.

6. The rotating-type data storage device anti-shake mechanism of claim 1, wherein the weighty members are integrally formed into a single piece.

7. The rotating-type data storage device anti-shake mechanism of claim 6, wherein the integrally-formed piece of weighty members is made from steel alloy.

8. The rotating-type data storage device anti-shake mechanism of claim 6, wherein the integrally-formed piece of weighty members is made from copper alloy.

9. The rotating-type data storage device anti-shake mechanism of claim 1, wherein the weighty members are each made from steel alloy.

10. The rotating-type data storage device anti-shake mechanism of claim 1, wherein the weighty members are each made from copper alloy.
